(19) United States
(12) Patent Application Publication
(10) Pub. No.: US 2026/0084991 A1
(43) Pub. Date: Mar. 26, 2026

(54) FLOATING SUBSTRATES INCLUDING CARBONACEOUS COATINGS FOR OFFSHORE CULTIVATION OF TARGET PRODUCTS AND METHODS OF MAKING AND USING THE SAME

(71) Applicant: Knudsen Holdings LLC, Cape Elizabeth, ME (US)

(72) Inventors: Justin Baker RIES, Swampscott, MA (US); Andrew Clyde THOMPSON, Biddeford, ME (US); Matthew Jordan ODLIN, Freeport, ME (US); Eben SARGENT, Anchorage, AK (US)

(21) Appl. No.: 19/197,224

(22) Filed: May 2, 2025

Related U.S. Application Data
(63) Continuation of application No. 18/894,753, filed on Sep. 24, 2024, now abandoned.
Application No. 18/894,753 is a continuation of application No. PCT/US2023/064919, filed on Mar. 24, 2023.
(60) Provisional application No. 63/323,286, filed on Mar. 24, 2022.

(51) Int. Cl. C02F 3/34; C02F 3/08; C02F 3/32; C02F 101/10; C02F 103/08

(52) U.S. Cl. CPC C02F 3/348; C02F 3/08; C02F 3/322; C02F 2101/10; C02F 2103/08; C02F 2203/006

(57) ABSTRACT

A method includes forming a substrate and coating at least a portion of the substrate with a coating. In some implementations, the coating is a carbonaceous coating. The coated substrate is deployed into a body of water. The coated substrate is at least one of pre-seeded with a target product before being deployed or configured to attract target product present in the body of water so as to become seeded with the target product after being deployed. The coating can transition from a first configuration to a second configuration to adjust a buoyancy of the coated substrate. In some embodiments, the coating is formulated to sequester carbon as it transitions from the first configuration to the second configuration. In some implementations, the coating can be configured to sequester carbon when deployed into the body of water with or without the target product being seeded on the substrate.

### CROSS-REFERENCE TO RELATED APPLICATIONS

This application is a continuation of U.S. patent application Ser. No. 18/894,753, filed Sep. 24, 2024, entitled “Floating Substrates Including Carbonaceous Coatings for Offshore Cultivation of Target Products and Methods of Making and Using the Same,” which is a continuation of International Patent Application No. PCT/US2023/064919, filed Mar. 24, 2023, entitled “Floating Substrates Including Carbonaceous Coatings for Offshore Cultivation of Target Products and Methods of Making and Using the Same,” which claims priority to and the benefit of U.S. Provisional Patent Application Ser. No. 63/323,286, filed Mar. 24, 2022, entitled “Floating Substrates Including Carbonaceous Coatings for Offshore Cultivation of Target Products and Methods of Making and Using the Same,” the disclosures of each of which is incorporated herein by reference in its entirety.

### BACKGROUND

The present disclosure relates generally to the cultivation of marine target products and more particularly, to carbonaceous coatings for floating substrates used for offshore cultivation of marine target products and/or carbon sequestration, and methods of making and using the same.

Advances in technology and industrialization have led to increasing amounts of harmful anthropogenic greenhouse gas emissions, which have contributed to global warming. One attempt at addressing the accumulation of atmospheric greenhouse gases is carbon sequestration, or the process of capturing and sequestering atmospheric carbon dioxide. To be atmospherically significant, however, it is generally desirable for carbon sequestration technologies to be capable of capturing carbon at a multi-gigaton scale. Marine species such as macroalgae, microalgae, crustaceans, planktons, filter feeders, and/or the like (also referred to as marine mass) have shown promise as a carbon sequestration technology as wild growth currently contributes to naturally occurring carbon sequestration to the seafloor. Therefore, increasing and/or improving cultivation and accumulation of marine mass can provide additional benefits.

The cultivation of marine species can have many advantages compared to the cultivation of plants on land. For example, the cultivation of marine mass typically leads to higher productivity and does not require significant use of scarce resources such as farmlands, freshwater, and/or additional nutrients. Known methods for cultivating marine mass, however, can be labor intensive, inefficient, difficult to scale, and/or expensive. For example, some known methods include cultivation near shore and/or the use of reusable/recoverable floatation elements, single-use engineered materials, multi-component assemblies, and/or the like. Moreover, some known floatation elements can be formed from materials designed to float for a desired time but may not provide additional advantages such as, for example, facilitating the seeding and/or development of target products, providing additional vehicles for carbon sequestration, and/or the like.

As such, a need exists for improved floating substrates for large scale carbon sequestration applications, materials used to form such substrates, and/or coatings for enhancing the performance of such materials and/or substrates.

### SUMMARY

Embodiments described herein relate to systems, devices, and methods that include the use of floating substrates for offshore cultivation of marine target products and carbon sequestration, and, in particular, to floating substrates that include or are coated with a one or more desired materials such as, for example, a carbonaceous material(s). The substrates and/or coated substrates may be used as an independent component for carbon sequestration purposes (or other independent purposes), may be embedded with a marine target product that is cultivated for carbon sequestration purposes, and/or a combination thereof. In some implementations, the coating(s) can be formulated to adjust a buoyancy of a substrate, release nutrients, promote attachment and/or growth of target product(s), sequestration of atmospheric and/or oceanic carbon, increase albedo of surface seawater increasing reflection of solar radiation and reduce warming of the body of water, mitigate effects of carbon dioxide induced ocean acidification by increasing alkalinity of the body of water, and/or the like.

In some implementations, a method includes forming a substrate and coating at least a portion of the substrate with a coating to form a coated substrate. In some implementations, the coating is, for example, a carbonaceous coating. The coated substrate is deployed into a body of water. The coated substrate is at least one of pre-seeded with a target product before being deployed or configured to attract target product present in the body of water so as to become seeded with the target product after being deployed. The coating is allowed to transition from a first configuration to a second configuration to adjust a buoyancy of the seeded substrate. In some embodiments, the coating is formulated to sequester carbon as it transitions from the first configuration to the second configuration. In some implementations, the coating can be configured to sequester carbon when deployed into the body of water with or without the target product being seeded on the substrate.

In some implementations, a method includes forming a substrate and coating at least a portion of the substrate to form a coated substrate. In some implementations, the substrate includes additives configured to promote growth of the target product. In some implementations, the substrate includes additives configured to suppress contamination of the target product. A seeded target product is allowed to grow for a period of time on the coated substrate. In some implementations, the period of time is a period of time for the target product to be integrated within the coated substrate. The coated substrate is deployed into a body of water after the period of time. The coating is then allowed to transition from a first configuration to a second configuration to adjust a buoyancy of the coated substrate.

In some implementations, a method includes forming a substrate and coating at least a portion of the substrate to form a coated substrate. In some implementations, the coating includes a silica fraction configured to adjust a buoyancy of at least one of the coating and the substrate. In some implementations, the coating is an aerated material including a surfactant foam. In some implementations, the coating includes an accelerant configured to alter at least one of the rate of hydration and the rate of mineralization of the coating. At least one of the coating and the substrate is seeded with a target product. In some implementations, seeding includes mechanically trapping target product within pores of at least one of the coating and the substrate. In some implementations, seeding includes infusing at least one of the coating and the substrate with target product. The coated substrate is deployed into a body of water and then the coating is allowed to transition from a first configuration to a second configuration to adjust a buoyancy of the coated substrate.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a flowchart of a method for cultivation of marine target products using a substrate coated with a carbonaceous material, according to an embodiment.

FIG. 2 is a schematic illustration of a cultivation apparatus including a coating formed from a carbonaceous material, according to an embodiment.

FIG. 3 is a schematic illustration of a cultivation apparatus including a first coating on a first side and a second coating on a second side of a substrate of the apparatus, according to an embodiment.

FIG. 4 is a schematic illustration of a cultivation apparatus formed from carbonaceous material, according to an embodiment.

FIG. 5 is a schematic illustration of a cultivation apparatus, according to an embodiment.

FIG. 6 is a plot of coating thickness of a carbonaceous coating on a substrate, which does not include any pumice, vs. the floating time of the substrate and dissolution time of the coating.

FIG. 7 is a plot of coating thickness of a carbonaceous coating on a substrate, which does not include any pumice, vs. the floating time of the substrate and dissolution time of the coating.

FIG. 8 is a plot of coating thickness of a carbonaceous coating on a substrate, which includes 10% pumice by weight, vs. the floating time of the substrate and dissolution time of the coating.

FIG. 9 is a plot of coating thickness of a carbonaceous coating on a substrate, which includes 20% pumice by weight, vs. the floating time of the substrate and dissolution time of the coating.

FIG. 10 is a plot of coating thickness of a carbonaceous coating on a substrate, which includes 30% pumice by weight, vs. the floating time of the substrate and dissolution time of the coating.

FIG. 11 is a plot of coating thickness of a carbonaceous coating on a substrate, which includes 35% pumice by weight, vs. the floating time of the substrate and dissolution time of the coating.

FIG. 12 is a plot of coating thickness of a carbonaceous coating on a substrate, which includes 40% pumice by weight, vs. the floating time of the substrate and dissolution time of the coating.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Interest in large-scale (e.g., on the order of multi-gigatons) sequestration of the biomass of target products (marine biomass) continues to increase as a pathway for addressing the accumulation of harmful anthropogenic greenhouse gases in the atmosphere. In addition, in an attempt to abate greenhouse gas emissions, governments and/or regulatory authorities have established greenhouse gas emissions caps and, where compliance is impracticable, have allowed organizations to comply with the emissions caps by purchasing carbon credits and/or offsets. For example, carbon sequestered using carbon sequestration technologies can be quantified, calculated, and/or valued, and a credit tied to and/or otherwise associated with the calculated amount of carbon sequestered can be sold in a carbon credit market (or any other suitable market). As prices in the global carbon credit market continue to climb, it remains desirable to improve and/or develop new systems, devices, and/or methods for carbon sequestration at a scale that is atmospherically significant for carbon sequestration applications.

Target products such as certain aquatic and/or marine species have shown promise as a carbon sequestration technology as a portion of their biomass naturally erodes or breaks away and sinks to the seafloor, sequestering any amount of carbon captured. Cultivation of such target products has the potential to improve this quantity and/or rate of sequestration significantly due to increased cultivation productivity relative to the naturally occurring species. In some implementations, cultivation can include seeding a substrate or structure with a target product, deploying the seeded substrate in a body of water such as open ocean, and allowing biomass to accumulate until reaching a certain threshold value. After accumulating a desired or threshold amount of biomass, the target product is allowed (or caused) to sink to the ocean floor, thereby effectively sequestering an amount of carbon dioxide captured by the target product.

Many marine target products (e.g., macroalgae) show promise as a carbon sequestration pathway as their wild growth currently contributes to naturally occurring carbon sequestration to the seafloor. Target product cultivation has the potential to improve this sequestration rate significantly due to increased cultivation productivity and sinking/sequestration rate relative to these naturally occurring phenomena. Target products can be cultivated in oceans, estuaries, lakes, rivers, and/or any other suitable body of water. These target products can be allowed to grow and accumulate biomass. Biomass may be corporeally retained or eroded (allowed to naturally break off and sink) into the water. Typically, after the accumulation reaches a certain threshold value, the target products are allowed to sink (or caused to sink) to the seafloor, thereby effectively sequestering the carbon dioxide associated with the accumulated target product.

Accordingly, carbon credits can be associated with the accumulation of the target product and/or capacity of the target product to sequester carbon. For instance, an amount of carbon that can be sequestered per unit of target product (e.g., that is sunk to the bottom of a body of water) can be calculated and/or predicted and sold in a carbon credit market (or any other suitable market) as a credit. In some instances, predicting growth, performance characteristics, and/or the capacity of the target product to sequester carbon can for example, enable the predicted capacity to be bought and/or sold as a commodity (e.g., in a commodities market, in a futures market, and/or in any other suitable market). Accordingly, accurately predicting target product accumulation and/or erosion can be useful to calculate carbon dioxide offset credits.

In some instances, systems and/or methods can use and/or implement a combination of multiple models (e.g., machine learning models, probabilistic models, statistical models, stochastic models, a combination thereof, and/or the like) to determine carbon dioxide offset credits. For example, a quantification model can receive as input, sensor data that is associated with a deployment and/or a portion of a deployment (e.g., one or more cultivation apparatus as discussed below) for cultivating target product. The quantification model can also receive outputs from at least one model from the multiple models. Each of these models can predict, for example, one or more characteristics associated with the target product, one or more characteristics associated with the deployment and/or the portion of the deployment, one or more characteristics associated with an environment in which the deployment and/or the portion of the deployment is deployed, and/or any other suitable characteristic. Executing the quantification model can generate an output that can predict and/or that can be used to predict a capacity of the target product of the deployment to sequester carbon dioxide. In some instances, carbon dioxide offset credits can be calculated based on the predicted capacity of the target product to sequester carbon dioxide. Since the quantification model uses the outputs from multiple models, the quantification model can predict the capacity of the target product with a higher degree of accuracy than a prediction based on each individual model.

In some embodiments, a method can include obtaining sensor data associated with at least a portion of a deployment for cultivating a target product in a body of water, executing at least one model based on the sensor data to generate an output predicting at least one characteristic associated with the target product, the deployment, and/or a portion of the body of water, and inputting the output into a quantification model. The quantification model is executed to generate an output associated with a predicted capacity of the target product to sequester carbon dioxide and a carbon dioxide offset credit is determined based on the predicted capacity resulting from output of the quantification model. An accuracy of the predicted capacity resulting from the output of the quantification model can be greater than an accuracy of a predicted capacity resulting from the output of each model individually.

In some embodiments, a method can include obtaining sensor data associated with a deployment for cultivating a target product in a body of water. The method can also include providing at least a portion of the sensor data as an input to at least one model from a number of models associated with the target product, the deployment, and/or a portion of the body of water in which the deployment is disposed. The models are executed in a predetermined sequence such that an output of a current model is an input for at least one subsequently executed model in the predetermined sequence. An output of a last model executed in the sequence is provided as input to a quantification model, which is executed to generate an output associated with a predicted capacity of the target product to sequester carbon dioxide.

In some embodiments, a method can include obtaining first sensor data from at least one sensor associated with at least one cultivation apparatus for cultivating a target product and second sensor data from at least one sensor associated with a deployment of any number of cultivation apparatus. The deployment being deployed in an ocean. The at least one cultivation apparatus being included in the plurality of cultivation apparatus. A first model is trained, based at least in part on the first sensor data, to generate a first output predicting at least one parameter associated with a growth of the target product of the at least one cultivation apparatus, and a second model is trained, based at least in part on the second sensor data, to generate a second output predicting a geographic dispersion of the deployment in the ocean. The method further includes training a third model, based at least in part on the first output and the second output, to generate a third output predicting an amount of accumulation of the target product of the deployment.

In addition to sequestering carbon captured by the target products, it may be desirable to source, form, and/or produce the substrate on which the target product is seeded to, or otherwise coupled to from naturally occurring materials (or from byproducts resulting from other processes) to limit carbon emissions associated with production. In addition or as an alternative, in some implementations, the naturally occurring material can sequester CO₂ directly in the production of the substrate, the transformation of the substrate, and/or the dissolution of the substrate (for example, via ocean alkalinization), and/or in the transport, deposition, and/or burial of the substrate if/when the substrate is removed from the surface of the body of water, the atmosphere, and/or a short-term carbon cycle in the coupled surface water-atmosphere system. In some implementations, it may be desirable to allow the substrates to sink along with the target product, thereby reducing carbon emissions otherwise associated with the process of recovering used substrates. Accordingly, a need exists for improved structures for offshore cultivation of target products and improved methods of make and using the same. Particularly, it is desirable to control floatation characteristics of substrates used for cultivation of marine target products. It is also desirable to have substrates that are formulated to sequester carbon in addition to, or alternatively to the target product.

The embodiments and/or methods described herein relate to cultivation apparatus or substrates that can be used for offshore cultivation of marine target products and that include and/or are coated with a carbonaceous material. Such cultivation apparatus or substrates may provide one or more benefits including, for example: (1) dissolving at a uniform rates to control floating or sinking of the substrate after a predetermined time; (2) releasing alkaline ions into the body of water, thus beneficially reducing acidity of the body of water in contrast to organic coating that release acid when dissolved thus, releasing carbon dioxide; (3) forming the coatings from naturally occurring materials, thus reducing introduction of synthetic materials into natural bodies of water (e.g., ocean, sea, rivers, lakes, ponds, etc.); (4) maintaining a surface having high free energy (e.g., high bonding potential) and high affinity for cation binding, thus promoting attachment of biological materials such as the target product via mineral binding or cation binding; (5) deterring biological degradation that may remineralize organic substrate as carbon dioxide before sinking to the body of water and/or burial; (6) buffering carbon dioxide released through biological decomposition (e.g., microbial decomposition, heterotrophic decomposition, etc.); (7) having sufficient density (e.g., greater than 1 g/cc or seawater density) to accelerate sinking of the substrate, for example, when rapid sinking is desired; (8) enabling entrapment of nutrients within a crystalline matrix and beneficially providing controlled release of the nutrients, for example, via dissolution of the coating; (9) increasing albedo of a surface of the body of water (e.g., seawater), thus promoting reflection of solar radiation and mitigating impact of carbon dioxide induced warming of the body of water via greenhouse effect; (10) mitigating impact of carbon dioxide induced acidification on marine calcifiers by releasing Ca²⁺ and CO₃²⁻ ions into the body of water; (11) promoting atmospheric carbon sequestration by directly capturing carbon dioxide from the atmosphere via dry (e.g., land based) mineralization; (12) using commercially available materials for forming the coating, thus decreasing manufacturing complexity, supply chain issues, and cost; and/or the like.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

As used herein, the term “target product” generally refers to one or more aquatic and/or marine species of interest. For example, a “target product” can include but is not limited to aquatic and/or marine species such as crustaceans, plankton, archaea filter feeders (e.g., oysters, clams, etc.), marine bacteria, heterokonts like algae(s) (e.g., microalgae, macroalgae, etc.), and/or the like. In other implementations, however, a target product can refer to any suitable species whose cultivation leads to a desired result (e.g., as a harvested product, for bioremediation, for carbon capture and sequestration, and/or the like).

The target products described herein can be select marine species who's natural and/or desired habitat is a body of water. When referring to a body of water, it should be understood that the body of water can be selected based on characteristics that may facilitate the cultivation of the target product. Accordingly, though specific bodies of water may be referred to herein (e.g., an ocean or sea), it should be understood that the embodiment, example, and/or implementation so described is not limited to use in such an environment unless the context clearly states otherwise. Moreover, the term “seawater” as used in this specification is intended to refer to any body of water the constituents of which include a certain concentration of salt(s). In contrast “freshwater” can refer to any body of water the constituents of which do not include or include limited concentrations of salt(s). Seawater, for example, can refer to the water forming oceans, seas, bays, gulfs, etc. Freshwater, for example, can refer to the water forming rivers, lakes, etc. Moreover, bodies of water described herein can also include certain mixtures of freshwater and seawater (generally known as “brackish”) such as, for example, the mixture of river water and seawater found in estuaries and/or the like.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

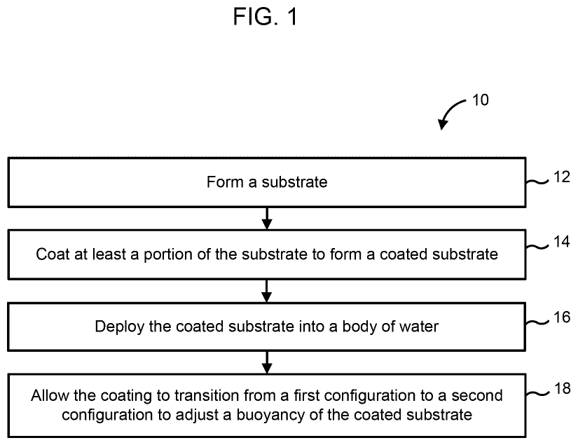

Referring now to the drawings, FIG. 1 is a flowchart of a method 10 for offshore cultivation of marine target products, according to an embodiment. The target product, as described herein, includes and/or encompasses a wide variety of species including microalgae, macroalgae, plankton, marine bacteria, archaea filter feeders (such as oysters or clams), crustaceans, or any other target product described herein, either for the purpose of bioremediation, eventual cultivation/harvesting, and/or for sequestering carbon dioxide. The target products may generally include negatively, neutrally, and/or positively buoyant species (e.g., species that sink, remain suspended, or float in water as they grow). Such target products may propagate or reproduce by producing gametophytes and/or sporophytes that can rapidly grow in a body of water and sequester atmospheric carbon via photosynthesis.

The method 10 includes forming a substrate, at 12. The substrate may have any suitable shape, for example, square, rectangular, ovoid, polygonal, asymmetric, irregular, and/or the any other shape. In some embodiments, the substrate may be a solid block. For example, strands, fibers, sheets, mats, and/or chunks of constituent material can be compressed into a solid block to form the substrate (e.g., via a mechanical or hydraulic press, a mold, and/or any other suitable process). In some embodiments, the compression can be such that a desired space exists between the strands, fibers, sheets, mats, and/or chunks to result in a substrate having a desired porosity, and/or the like. In some embodiments, the substrate may be hollow or may be formed into a hollow block. For example, the substrate may define one or more internal volumes, cavities, receptacles, and/or voids (e.g., to trap or hold air, thereby increasing a buoyancy of the substrate), or may be formed in the shape of a cage or a net. The substrate may be positively buoyant, allowing the substrate to float on a body of water, for example, an ocean, a sea, a river, a lake, a pond, etc., at least for a certain period of time or under certain environmental conditions. In some embodiments, the substrate may be or may become neutrally buoyant or negatively buoyant, as described herein.

The substrate may be formed from any suitable material. In some embodiments, the substrate may be formed from a naturally occurring material. The naturally occurring material may generally include an organic material that is readily available in natural environments, or is produced naturally as the main product or byproduct of farming or other cultivating/harvesting operations. For example, the naturally occurring material may include an agricultural waste product or a forest waste product. In various embodiments, the naturally occurring material may include, but is not limited to biomass (e.g., woody biomass) such as, for example, to grasses (e.g., switch grass, wild grass, genetically modified grass, etc.), wood chips (e.g., obtained from downed trees or wood reclamation operations), wood excelsior fibers, straw fibers, hog fuel, corn cobs, coconut shells, coconut fibers, hemp, jute, compost, xanthum gum, agar, alginate, limestone (calcium carbonate (CaCO₃)), dolomite or dolostone (calcium magnesium carbonate (CaMg(CO₃)₂)), magnesite (magnesium carbonate (MgCO₃)), lime (calcium oxide (CaO)), slaked or hydrated lime (calcium hydroxide (Ca(OH)₂)), brucite (magnesium hydroxide (Mg(OH)₂)), magnesium oxide (MgO), pumice (for buoyancy), alkaline mafic/ultramafic metal silicate minerals and/or rocks (to sequester CO₂ via ocean alkalinization and/or for buoyancy), naturally occurring carbonates and other salts, air or other compressed gas (for porosity, permeability, and/or buoyancy), any other suitable organic and/or inorganic product, waste product, and/or any combination(s) thereof. In some embodiments, the naturally occurring material may be a biobased material, or biodegradable polymer (e.g., polyhydroxyalkanoate based aliphatic polyesters) produced from natural materials such as sugar, oils, molasses, coconut oil, palm oil, chitin, etc. The naturally occurring materials (e.g., the biomass, biobased material, biodegradable polymers, etc.) may be formulated to naturally biodegrade in water (e.g., freshwater, saltwater, brackish water, etc.), for example, via hydrolysis and/or enzymatic digestion and/or otherwise formulated to lose buoyancy over time.

The naturally occurring material may be formed into the substrate using any suitable process. In some embodiments, the substrate may be formed by placing and/or forming the naturally occurring into one or more tubes, tube-like structures, meshes, socks, bags (e.g., a bag, a pouch, a bailer, or any other container defining an internal volume), over braids, spiral wraps, wattles, slit socks, ropes (e.g., similar to those used to prevent land erosion, or flood barriers), and/or the like. In some embodiments, the substrate can be formed with any number of layers (with or without one or more base layers) formed from naturally occurring material such as, for example, coconut fibers, wood excelsior fibers, straw fibers, natural twine, compost, biobased biodegradable plastic perforated fabric, mesh formed into a tubular structure, and/or the like. In some embodiments, the naturally occurring material may be formed into the planar substrate by stitching, weaving, laminating, or otherwise compressing between the two or more sheets (e.g., scrim fabrics, perforated sheets, meshes, rovings, etc.) to form the substrate (e.g., flat sheets or mats). In some embodiments, the naturally occurring material may be mixed with an adhesive or binder before forming into the block, or an adhesive or binder may be poured over, or otherwise applied to the substrate after being formed into the block so as to cause the substrate to retain its shape. In such embodiments, the adhesive or binder may include a biocompatible, or otherwise biodegradable adhesive or binder, including, but not limited to beeswax, gelatin, molasses, tree sap, protein based polymers, any suitable biodegradable polymer, or combination thereof. In some embodiments, the adhesive or binder may include of be spiked with nutrients, fertilizers, or other additives to promote growth of the target product therein. Accordingly, any of the substrates described herein can be formed from naturally occurring materials and/or can be formed using methods such as any of those described in detail in U.S. Provisional Application No. 63/323,285, filed Mar. 24, 2022, and entitled “Floating Substrates for Offshore Cultivation of Target Products and Methods of Making and Using the Same,” the entire disclosure of which is incorporated herein by reference.

At 14, at least a portion of the substrate is coated to form a coated substrate. Expanding further, the coating may be or may include a carbonaceous material such as a carbonate fraction (also referred to herein as “aggregate”), which can be used, for example, to facilitate dissolution of the coating, provide carbon dioxide (CO₂) sequestration via alkalinization, and/or provide ballast for the substrate. In some embodiments, the carbonaceous material may include CaCO₃ (e.g., crushed limestone), CaMg(CO₃)₂ (e.g., crushed dolostone), and/or MgCO₃ (e.g., magnesite). In some embodiments, the coating may also include a silicic fraction, for example, pumice and/or other low density vesicular rock (e.g., mafic rock, ultramafic rock, and/or minerals) to enhance buoyancy of the coating and/or the substrate. In some embodiments, the coating may also be mixed with a surfactant foam to create an aerated final material.

In some embodiments, the coating may include a metal oxide fraction such as, for example, iron oxide (Fe₂O₃) and/or other iron (Fe) or manganese (Mn) bearing oxide (e.g., to adjust buoyancy, for ballast, and/or to control orientation of substrate when applied to one side). In some embodiments, the coating may include one or more organic or inorganic binders, for example, to hold the carbonaceous material together and adhered to the substrate. Suitable binders may include, but are not limited to carbonate binders (e.g., CaO, Ca(OH)₂, etc.), MgO, Mg(OH)₂, and/or other cementitious binder, or organic binders, for example, organic resin, polysaccharide gel, proteinaceous binder, adhesive, any other suitable organic binder, or combination thereof. In some embodiments, the coating may include an accelerant to increase or decrease the rate of hydration and/or mineralization of the coating. In some embodiments, the coating may include one or more additives, for example, nutrients such as nitrogen (N), phosphorous (P), iron (Fe), and/or minor/trace elements in proportions supportive of photosynthesis and vegetative growth of the target marine product. In some embodiments, the coating may include a catalyst, for example, freshwater, seawater, subsurface, or surface brine. In some embodiments, the catalyst may not be included in the coating, and instead may be provided by the body of water (e.g., seawater).

The coating may be applied on the substrate using any suitable method. For example, the aggregate, binder, and additives may be mixed with water, seawater, and/or brine, and used to coat floating and/or sinking substrates deployed in ocean and natural water bodies. In some embodiments, the coating may be disposed on the substrate by disposing the substrate in cages that are suspended from a circulating cable (e.g., a ski chair lift cable), and are passed through or dipped in vessels containing a mixture of the coating material (e.g., a slurry, suspension, etc.). In some embodiments, the cages may include polytetrafluoroethylene (PTFE) (e.g., Teflon™ or Teflon™ coated) cages that may move at a rate of about 40 cages/hour to about 60 cages/hour, inclusive, through the vessels, for example, to provide a production target in a range of about 200 ton/hour to about 600 ton/hour, inclusive. In some embodiments, the cages may be transported through a furnace (e.g., furnace tunnels) between coating applications to cure the coating. In some embodiments, the substrate may be disposed on a conveyor system (e.g., a walled conveyor system) and moved through vessels of the coating, or the coating may be sprayed or otherwise, deposited on the substrate as the conveyor moves. In some embodiments, the conveyor may also move through furnaces to cure the coating, as described herein. In some embodiments, the conveyor may have a width of about 6 meters and a depth of about 0.5 meters, inclusive, and may be configured to move at a rate of about 10 cm/second to about 20 cm/second, inclusive, for example, to provide a throughput of 200 ton/hour to about 600 ton/hour, inclusive.

At 16, the coated substrate is deployed into a body of water, for example, an ocean, a sea, a river, a pond, a lake, a river, or any other body of water. In some embodiments, the substrate may be seeded with the target product before being deployed (e.g., pre-seeded). For example, the coated substrate may be seeded immediately before deployment in the body of water such that growth of the target product occurs substantially within the body of water. In other embodiments, the seeded target product may be allowed to grow or germinate for a period of time before deployment into the body of water, with subsequent growth of the seeded target product occurring in the body of water. Allowing the seeded target product to grow for the period of time prior to deployment may advantageously allow the target product to become integrated within the coated substrate such that the seeded target product is inhibited from dissociating from the coated substrate when the coated substrate is deployed into the body of water such that all or a significant portion of the seeded target product remains attached to or incorporated within the coated substrate after deployment.

The target product (e.g., gametophytes or sporophytes of marine algae, or any other target product described herein or biological component thereof) may be seeded into the substrate and/or into the coating. Seeding may be performed by disposing the target product in or on the material (e.g., the naturally occurring material used to form the substrate) before the substrate is formed, during formation of the substrate, after formation of the substrate, before or after coating the substrate with the coating, for example, by immersing the substrate in a volume of liquid (e.g., seawater, saltwater or culture medium) within which the target product is being grown or stored allowing a portion of the target product included in the volume of liquid to become trapped in the pores of the substrate and/or the coating, thereby forming the coated and seeded substrate. The target product may be mechanically trapped within the substrate, for example, within pores that may be present in the substrate and/or the coating, or infused into the substrate and/or the coating.

In some embodiments, the coated substrate (e.g., the naturally occurring product and/or the coating) may include binders or other materials to facilitate adhesion of the target product to the substrate. For example, cationic binders, hydrogels, adhesives, polymers, or other seed binders may be included in the substrate to attract the target product (e.g., sporophytes or gametophytes) towards the substrate and keep the target product in proximity of the substrate until a strong adhesion or attachment is formed between the target product and the substrate. Other substances that may be used to enhance adhesion of the target product to the substrate may include, but are not limited to rheology modifiers, agglutinants, and other additives including glycerol, molasses, high molecular weight polysaccharides, and other polymeric materials such as polyethylene oxide.

In some embodiments, the substrate (e.g., the naturally occurring product and/or the coating) may include (e.g., be spiked or infused with) nutrients, fertilizers, or other additives to promote growth of the target product therein. For example, one or more portions of the substrate (e.g., the naturally occurring material and/or coating) may be sprayed with a fertilizer formulated to accelerate growth of the species of the target product. In some embodiments, the substrate may include additives formulated to suppress contamination of target product. For example, the substrate can include, be saturated with, or be impregnated with a growth substrate material such as, for example, an enriched seawater medium, pasteurized seawater, filtered seawater, seawater mixed with buffer solutions including but not limited to sodium nitrate (NaNO₃) solution, potassium dihydrogen phosphate (KH₂PO₄) solution, germanium dioxide (GeO₂), and/or the like. In some embodiments, the substrate may be infused with iron particles, or co-winded, coiled, and/or intertwined with an iron or an iron-containing thread, filament, or string to provide a source of iron (Fe) nutrient to the target product.

In some embodiments, one or more portions of the substrate may be inoculated with one or more diazotroph microorganisms including single-celled archaea organisms, bacteria such as cyanobacteria, azotobacter, rhizobia, Frankia, and/or the like (e.g., microbiota), capable of converting molecular nitrogen (N₂) from air into ammonia (NH₃) (e.g., fixing nitrogen). As previously described, the substrate (e.g., the naturally occurring material and/or the coating) may be porous. The porous nature of the substrate may provide passive release of the fertilizer, additives, growth promoters, or other substance infused therewithin overtime, thus providing continuous dosing of such substances to the seeded target product, and/or retain such substances in close proximity of the target product.

While the coated substrates are described above as being seeded (e.g., actively or otherwise pre-seeded prior to deployment), in other implementation, the coated substrates can be deployed into a body of water without being seeded. In such implementations, the coated substrate may be configured to attract and retain target products (or biological components thereof) naturally present in the body of water. Moreover, in some such implementations, the coated substrates can be configured to include and/or release any of the substances, binders, nutrients, fertilizers, additives, growth promoters, etc., which in turn, can attract and/or retain target product (or biological components thereof) naturally present in the body of water in which the substrate is deployed, thereby allowing natural or passive seeding of the substrate. In some implementations, a coated substrate can be pre-seeded and can be configured to attract and/or retain target products (or biological components thereof) naturally present in the body of water in which the substrate is deployed.

In some embodiments, individual coated substrates (e.g., pre-seeded substrates) may be deployed independently in the body of water. In such embodiments, the coated substrates may be relatively short in length. In some embodiments, multiple coated substrates may be aggregated or otherwise coupled to each other (e.g., via the coating) to form an aggregate or array of coated (and seeded) substrates that are deployed together in the body of water. Such aggregates or arrays may be formed by coiling, chaining (e.g., via twines, ropes, or chains), stacking, or coupling together in any suitable arrangement to form the aggregate. The aggregates may advantageously have higher mechanical strength than individual seeded substrates. Moreover, forming aggregates may also advantageously at least partially shield adjacent seeded substrates included in the aggregate from waves, currents, and wind action, thereby inhibiting removal, erosion, and/or breakage of the seeded target product, fertilizers, nutrients, additives, or binders from the seeded substrate. In some embodiments, the carbonaceous coating may be used to form aggregates of the coated substrate. For example, the CaCO₃ based coating may be used to not only coat, but also to aggregate individual substrates into a larger, composite mass of substrates and coating. Such aggregates be useful when a larger sized float is desired, for example, to serve as a larger, more buoyant, and/or longer floating substrate for supporting the growth of larger, and/or longer-lived target product. Such linked substrates may also be used to create large, high-density aggregates of substrate and coating materials to be rapidly sunk from the surface body of water to the floor of the body of water (e.g., sea floor).

At 18, the coating is allowed to transition from a first configuration to a second configuration to adjust a buoyancy of the substrate. In some embodiments, a buoyancy of the substrate in the first configuration may be greater than a threshold buoyancy and a buoyancy of the substrate in the second configuration is less than a threshold buoyancy. For example, in the first configuration the coating may have a positive buoyancy sufficient to cause the substrate to have a positive buoyancy and causing the substrate to float. In the second configuration, the buoyancy of the coating may decrease causing the substrate to also have a negative buoyancy and sink, for example, to sequester carbon captured by the target product as it grows and/or by the coating, as described herein. In some embodiments, the coating may have a first volume in the first configuration, which is greater than a second volume of the coating in the second configuration. For example, the coating may dissolve or disintegrate in the body of water over a period of time, thus losing volume and causing the buoyancy of the substrate to reduce until the substrate sinks into the body of water. In some embodiments, the coating may also be formulated to sequester carbon from the atmosphere as it transitions from the first configuration to the second configuration.

Expanding further, the composition of the coating and/or its thickness may control buoyancy and therefore, float time of substrate (e.g., ranging from prompt sinking to years of floating). In some embodiments, the coating may be formulated to extend float time of the substrate, for example, by adjusting coating and/or substrate composition and/or thickness to delay uptake of water into the buoyant substrate. The coating may gradually dissolve, causing loss of buoyant fraction of aggregate and allowing water to diffuse into substrate, eventually sinking the substrate, for example, after the coating has sufficiently dissolved or disintegrated in the body of water. In some instances, increasing float time of substrate may promote settlement and growth of the target product on the substrate, which will sequester CO₂ via photosynthesis and will be transported to a bottom of the body or water (e.g., seabed) when the coating partially or wholly dissolves. For example, the partially or wholly dissolved coating can allow water to intrude the floating substrate, which can result in the combined mass (e.g., substrate and target product) sinking.

The coating may remain on the substrate at time of sinking, thereby inhibiting biological decomposition of substrate, and/or reducing release (e.g., via remineralization) of CO₂ previously sequestered in the substrate as organic carbon. In some embodiments, to shorten float time and accelerate sinking, the coating composition and/or thickness may be optimized to make the coated substrate negatively buoyant such that the substrate sinks upon deployment in the body of water (e.g., ocean or other natural or man-made water body).

The coating disposed on the substrate may provide numerous advantages relative to substrates that do not include any coating dispose thereon. By way of example and not limitation, some such benefits are described below.

In some instances, any of the coatings described herein can allow for sequestration of CO₂ from the surface water and/or the atmosphere directly, for example, with or without a target product being seeded on the coated substrate. For example, all or a portion or fraction of the coating can be mineralized when deployed in a body of water (e.g., an ocean or a sea). More specifically, the coating may include a CaCO₃ fraction, which may sequester CO₂ from the surface water and/or the atmosphere via alkalinization as the CaCO₃ included in the coating dissolves. For example, the dissolution of the CaCO₃ fraction of the coating (e.g., crushed limestone and mineralized binder) will yield Ca₂ and CO₃²⁻ ions via the following reaction:

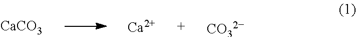

The liberated CO₃²⁻ ions may take up free H′ (protons) via the following reaction:

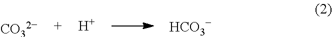

As will be understood, the reaction decreases free H⁺ in the water, thereby increasing pH (alkalinity) of at least the surface level of the body of water (e.g., the reaction can result in ocean alkalinization). For example, the alkalinization just described can, for example, shift the carbonate equilibria in the following reaction to the right, resulting in a net transfer of atmospheric CO₂ to aqueous CO₂ to reestablish the carbonate equilibria:

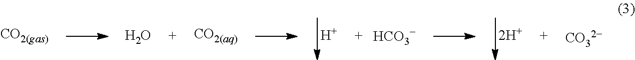

In some instances, release of alkalinity in the form of CO₃²⁻, HCO₃⁻, and/or OH⁻ from, for example, mafic rocks, ultramafic rocks, and/or minerals included in the coating may also sequester atmospheric CO₂ via alkalinization of a surface of the body of water (e.g., seawater). For example, pulverized ultramafic rocks, mafic rocks, and/or minerals (e.g., olivine, serpentine, peridotite, etc.) may also be included in the coating to sequester atmospheric CO₂ through the release of additional alkalinity in the form of CO₃²⁻, HCO₃⁻, and/or OH⁻ via the chemical weathering of these pulverized rocks and/or minerals.

In some instances, the above reactions can result in the sequestration of approximately 0.6 moles of CO₂ from the atmosphere to the surface of the body of water per mole of CaCO₃ included in the coating dissolved in the body of water.

In some instances, any of the coatings described herein can allow for direct capture of CO₂ from the atmosphere during dry (e.g., land-based) mineralization of one or more binder component(s) of the coating (e.g., Ca(OH)₂, Mg(OH)₂, or any other suitable binder) as CaCO₃ and/or MgCO₃. The land-based mineralization of the binder component of the coating as CaCO₃ and/or MgCO₃ may sequester 1 mole of CO₂ from the atmosphere per 1 mole of Ca(OH)₂ mineralized as CaCO₃ via the following reaction:

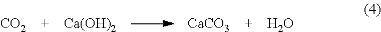

Contrary to the mineralization of CaCO₃ from dissolved Ca²⁺ and CO₃²⁻ ions in the body of water (which converts HCO₃⁻ to CO₂ in seawater, thereby releasing CO₂ to the atmosphere), the dry (e.g., land-based) mineralization of CaCO₃ does not release CO₂, because the CO₂ (e.g., atmospheric or atmosphere-derived CO₂) is the source of carbon involved in the conversion of the Ca(OH)₂ binder to the mineralized CaCO₃, which is immediately converted to CO₃²⁻ in the high-pH (e.g., pH>10) coating composition (e.g., slurry, suspension, or colloid).

In some instances, any of the coatings described herein can allow and/or can provide a waterproofing barrier to prolong float time associated with a substrate, buoy, or floating component. For example, the CaCO₃ based coating may extend float time of permeable substrates (e.g., naturally occurring material) with a density less than that of the body of water (e.g., <1) by delaying uptake of water (e.g., seawater) into the permeable substrate. The extent to which the coating inhibits uptake of water and extends float time may be adjusted by changing the thickness, porosity (e.g., volume of pores), permeability (e.g., connectivity of pores), grain size, percentage of pumice, and/or other properties of the coating. Prolonging the float time of the substrate may be beneficial to the extent that it will provide more time for the dissolution of the CaCO₃ fraction of the coating in the surface waters, which will sequester CO₂ as described herein, and provide more time for the settlement and growth of the target product that will sequester CO₂ through photosynthesis, as described herein.

In some instances, any of the coatings described herein can allow and/or can provide an inert ballast to rapidly sink a substrate if secondary growth is not desired. For example, while it may generally be desirable to extend float time of substrates, in some implementations, the coating may also or alternatively be formulated to decrease float time of the substrate and/or even cause immediate sinkage of the substrate. For example, a transition of the coating from the first configuration to the second configuration may be very rapid so as to cause the buoyancy of the substrate to drop below the threshold buoyancy (e.g., have a negative buoyancy and/or have a density<1) causing the substrate to sink soon after the seeded/coated substrate is deployed on the body of water. This may be achieved by increasing the thickness and/or density of the coating so that the effective combined density of the substrate and the coating exceeds the density of the body of water (e.g., seawater having a density around about 1.02 grams per cubic centimeter (g/cm³) to about 1.03 g/cm³) on which the substrate is deployed. In such embodiments, the impact of the coating may be more environmentally benign than other coatings because the primary components of the coating including CaCO₃ and pumice are commonly available in the marine environment and are amongst the dominant rock and sediment types that occur in the ocean, both floating in the upper water column and on the seabed. Thus, sinking of the substrate does not introduce synthetic substances or other substances that are not normally found in the body of water, into the body of water.

In some instances, any of the coatings described herein can allow and/or can provide controlled dissolution of the CaCO₃ based coating to assist in transport of the target product—and thus, associated CO₂ sequestered into the target product through photosynthesis as the target product grows—to the floor of the body of water (e.g., the sea floor). For example, as CaCO₃ included in the coating dissolves, the coating may transition from serving as a source of buoyancy (e.g., via pumice floatation and delay of water uptake into the substrate) to a source of ballast, which will trigger and/or accelerate the sinking of the target product seeded on the substrate (and an amount CO₂ captured by the target product) to the floor of the body of water.

In some instances, any of the coatings described herein can allow and/or can provide for modification of surface chemistry, free energy, topography, and/or texture in support of target product adhesion, settlement, recruitment, and/or growth. For example, the CaCO₃ based coating may be tailored to increase settlement and growth of CO₂ capturing target product on the surface of the substrate by changing the surface chemistry, free energy (e.g., chemical bond-forming potential), topography, and/or texture of the coating surface. One pathway by which this may occur is through the build-up of free Ca²⁺ ions at the boundary layer of the coating as it dissolves. These Ca²⁺ ions may result in a stiffening of polysaccharide adhesives used in the holdfast structures of the target product (e.g., marine plants) to attach to hard substrates, which is one of the reasons that macroalgae such as kelp, and even marine invertebrates, preferentially attach to naturally occurring CaCO₃ substrates, such as crustose coralline algae and mollusk shells.

In some instances, any of the coatings described herein can allow and/or can provide mechanical and/or chemical inhibition of biological remineralization of organic matter on a floor of the body of water or on the surface thereof. For example, the CaCO₃ in the coating may inhibit the biological (e.g., microbial and/or heterotrophic) remineralization of the sinking substrate (e.g., a substrate formed from a naturally occurring material), thereby preserving the CO₂ (and its associated value) sequestered in or by that substrate and preventing associated release of nutrients to the environments through which the substrate is transported and ultimately deposited. Mechanically, the coating may act as a physical barrier to microbial degradation and/or higher-level heterotrophy degradation. Chemically, the dissolution of the coating may generate a higher pH at the millimeter (mm)-scale boundary layer around the substrate and/or target product that may deter microbial colonization of the substrate as well as convert any remineralized CO₂ back to HCO₃⁻ in the high pH boundary layer. If a portion of the coating remains on the substrate at the time that it has taken up sufficient water to sink, then this inhibition of CO₂ remineralization via mechanical and/or chemical methods may continue as the substrate sinks through the water column and/or may also continue while on the sea floor. This may also increase the likelihood that the substrate is transported all the way to the floor of the body of water, and ultimately be buried and preserved in sediments, effectively sequestering the captured CO₂ from the coupled upper ocean/atmospheric system for geological timescales.

In some instances, any of the coatings described herein can allow and/or can provide buffering of CO₂ (e.g., conversion of CO₂ to HCO₃⁻ and CO₃⁻ via a drawdown of H) released through biotic remineralization of an organic substrate on a seafloor as the carbonate coating dissolves. For example, the organic substrate may be partially remineralized to CO₂, which would reduce the pH (i.e., acidify) adjacent waters (e.g., due to an increase of protons), potentially deleteriously impacting organisms and/or ecosystems within those waters. In some implementations, dissolution of the CaCO₃ coating in the locally acidified water may buffer the acidification by removing protons in the conversion of CO₃²⁻ to HCO₃⁻, thereby mitigating the secondary impacts of localized acidification arising from CO₂ remineralization.

In some instances, any of the coatings described herein can allow and/or can provide for an increase in albedo of the surface of the body of water. For example, the coating may be formulated to increase the surface albedo of seawater (e.g., a measure of the ability of seawater surface to reflect sunlight and/or solar radiation) from a lower range of about 0.05-0.15, inclusive (e.g., open seawater) to about 0.4-0.8, inclusive, for crushed limestones, which increase reflection of shortwave solar radiation and mitigate impacts of CO₂ induced warming resulting from greenhouse effect. Specifically, increasing atmospheric and oceanic temperatures may be a byproduct of elevated atmospheric CO₂, which traps solar radiation via the greenhouse effect. The CaCO₃ based coatings described herein may have a higher albedo (e.g., in a range of about 0.4 to about 0.8, inclusive) and therefore, may reflect more solar radiation than seawater, which has an albedo of about 0.05 to about 0.15, inclusive. The deployment of CaCO₃ coated floating substrates in the surface ocean would therefore increase the amount of solar radiation that is reflected from a surface area of ocean, thereby reducing CO₂ induced greenhouse effect and the resulting atmospheric and oceanic warming.

In some instances, any of the coatings described herein can mitigate the effects of CO₂ induced ocean acidification on marine calcifiers by elevated releasing Ca²⁺ and CO₃²⁻ ions through mineral dissolution, thereby elevating a saturation state of the body of water (e.g., seawater) with respect to calcite and aragonite. For example, increasing atmospheric CO₂ decreases the pH of surface sea/ocean water, a process known as ocean acidification. Ocean acidification reduces the carbonate ion CO₃²⁻ concentration and CaCO₃ saturation of surface sea/ocean water, making it harder for some species of marine calcifiers to build their CaCO₃ shells and skeletons and increasing the rate that exposed portions of their shells and skeletons dissolve. Dissolution of CaCO₃ based coatings of substrates in surface and/or shelf waters may remove protons through protonation of the released CO₃²⁻ ions and increase Ca²⁺ concentrations in sea/ocean water (both of which contribute to elevating the CaCO₃ saturation state of seawater), thereby reversing the effects of CO₂ induced ocean acidification and mitigating these impacts on marine calcifiers. Therefore, dissolution of CaCO₃ based coatings in surface and/or shelf waters, and the resulting alkalinization of these waters, may not only mitigate the impacts of global warming by drawing down atmospheric CO₂ and increasing albedo of the surface ocean, but may also mitigate the impacts of CO₂ induced ocean acidification on marine organisms by removing free protons via protonation of CO₃²⁻ and elevating dissolved Ca²⁺ concentration.

In some instances, any of the coatings described herein can allow for and/or can provide a vessel for slow (or slower) release of nutrients as the coating dissolves (e.g., can serve as a “fertilizer stake” for marine algae). For example, the CaCO₃ based coating may also serve as a vehicle or source for the relative slow-release of certain nutrients (e.g., NO₃⁻, PO₃⁴⁻, Fe, and trace elements) to the target product colonizing the substrate, thereby increasing their growth rates and amount of CO₂ sequestered via photosynthesis. CaCO₃ may function as a “geochemical sponge” for other dissolved ions, with the concentration of ions incorporated into the CaCO₃ lattice increasing with the concentration of the solution from which it precipitates (hence the use of naturally occurring CaCO₃ in the ocean as a proxy for reconstructing past changes in ocean chemistry).

Other ions such as NO₃⁻, PO₃⁴⁻, and Fe can all be co-precipitated with CaCO₃ at concentrations in a range about 1% to about 2%, inclusive, by weight. The NO₃⁻ and PO₃⁴⁻ tend to substitute for CO₃²⁻ (the anion) in the CaCO₃ lattice, while Fe substitutes for Ca²⁺ (the cation). Higher concentrations of nutrients could be incorporated if the nutrients are simply entrapped in the carbonate coating, rather than being co-precipitated (i.e., mineralogically substituting into the CaCO₃ lattice). For both approaches, the specific nutrient ratios in the CaCO₃ coating may be tailored by modifying their ratios in the solution or slurry from which the CaCO₃ is precipitated. The nutrients would then be gradually released into the surface waters in those same ratios as the CaCO₃ coating dissolves, with the rate of dissolution of the coating controlled by modifying the solubility of the CaCO₃ coating (e.g., by modifying its porosity, permeability, binder fraction, Mg/Ca ratio, concentration of pumice, or other properties impacting solubility). This application is analogous to terrestrial fertilizer stakes (e.g., used to deliver nutrients to trees)—with the stake being engineered to dissolve under specific pH conditions of the body of water rather than specific soil pH conditions.

In some embodiments, the growth of the target product on the substrate results in biomass accumulation on the substrate, which may also affect the buoyancy of the substrate. In some embodiments, a buoyancy of the seeded substrate in the first configuration is greater than the threshold buoyancy and a buoyancy of the seeded substrate in the second configuration is less than the threshold buoyancy. The threshold buoyancy may be based at least in part on a degree of negative buoyancy associated with the threshold amount of biomass accumulation. That is to say, a desired amount of biomass accumulation can dictate and/or at least partially determine the threshold buoyancy (e.g., the coating also partially contributing to determine the threshold buoyancy).

For example, the substrate can be and/or can include materials that are positively buoyant (i.e., float in water), as previously described. In contrast, the target product seeded in the substrate may be naturally negatively buoyant (i.e., sinks in water), or may become increasingly negatively buoyant as the target product matures. The buoyancy of the seeded substrate may therefore be based on the buoyancy of the substrate, the buoyancy of the coating, and the buoyancy of the target product incorporated therein.

In the first configuration, the seeded target product, which may or may not be partially grown before deployment in water, may have a first biomass having a first amount of negative buoyancy that is less than a first amount of positive buoyancy of the substrate. Thus, in the first configuration, the seeded substrate has an overall positive buoyancy such that the seeded substrate floats on the body of water when initially deployed. Over a period of time, the seeded target product accumulates biomass as it captures, absorbs, and/or sequesters atmospheric CO₂ and grows. Moreover, the coating may also sequester carbon, degrade, and/or disintegrate decreasing its buoyancy, as described herein. The accumulation of biomass, in turn, increases an amount of negative buoyancy associated with the target product. Moreover, water may accumulate within the porous seeded substrate reducing the positive buoyancy of the substrate.

Once a threshold amount of biomass of the target product is accumulated in the seeded substrate, the threshold amount of biomass may have a second amount of negative buoyancy that is greater than the first amount of positive buoyancy of the substrate, causing the seeded substrate (e.g., substrate+target product) to have a buoyancy that is less than the threshold buoyancy, which is based at least in part on the degree or amount of negative buoyancy associated with the threshold amount of biomass accumulation. Thus, in the second configuration, the seeded substrate may sink below surface carbon cycles (e.g., to the floor of the body of water), thereby trapping and/or sequestering the captured carbon within the body of water (e.g., below the surface carbon cycles). Since the substrate and the coating includes naturally occurring materials and the target product includes naturally occurring organisms, the seeded substrate has a negligible impact on the environment (e.g., a marine environment), and, in some instances, may improve the environment by providing a nutrition source for animals and organisms that may reside near the floor or bottom of the body of water.

In some embodiments, the seeded substrate may transition from the first configuration to the second configuration via removal or degradation of at least portions of the substrate (e.g., the coating). For example, the naturally occurring product included in the substrate, the one or more base layers included in the substrate, the one or more binders included in the substrate, and/or the coating may be naturally biodegradable (e.g., via hydrolysis, decomposition, disintegration, and/or enzymatic digestion by organisms that may be naturally present in the water, or degrade due to exposure to ultraviolet (UV) radiations of the sun). Degradation of the substrate may occur over a period of time causing the positive buoyancy of the substrate to decrease, while the negative buoyancy of the target product seeded therein increases as it grows until the buoyancy of the seeded substrate decreases to be less than the threshold buoyancy causing and/or otherwise allowing the seeded substrate to sink in the body of water.

In some embodiments, the coating formed from the carbonaceous material may be formulated for generation of alkalinity, carbonate aggregate, and/or binder in coating process by electrolysis. For example, a low-voltage electrical current may be applied across the reaction vessel in which the coating is applied to the substrate, with the anode near the surface of the vessel, and cathode near base of vessel. The electrical current may cause a concentration of OH ions near the surface of the coating, supporting precipitation of carbonate minerals on the floating substrates. This method may be used independently, or in combination with any of the coating methods described above.

In some embodiments, the substrate may itself be formed in full or in part from the carbonaceous material. For example, in some applications it may be beneficial to eliminate the floating substrate from the process and produce a floating or sinking substrate exclusively from the carbonaceous material (e.g., crushed limestone and/or dolostone), the binders (e.g., Ca(OH)₂ and/or Mg(OH)₂), pumice, and other additives. Such a substrate would sequester CO₂ through the mineralization of the binder and dissolution of the CaCO₃ fraction in the body of water (e.g., seawater). The floating time of mass of the carbonaceous material, which would include the entire substrate, may be controlled by the same factors previously described herein (e.g., porosity, permeability, density, percentage of pumice, etc.) and would promote settlement, attachment, and growth of vegetative matter for the same reasons as when the carbonaceous material is applied solely as a coating on a secondary substrate of lower density. CaCO₃ based coatings of different physical properties could also be layered to produce a lower density CaCO₃ based substrate that is coated with a higher density CaCO₃ based coating, or vice versa.

In some embodiments, opposite sides of substrate may be coated with different coatings, for example, a high-density coating and a low-density coating to confer preferential orientation to substrate as it floats. For example, different sides of the substrate may be coated with materials of differing densities to confer a preferential orientation of the substrate as it floats and/or sinks in the body of water (e.g., a sea or an ocean). Examples of higher density coatings that would become preferentially oriented in a downward direction include, but are not limited to metal oxides, such as iron and manganese-oxides. Such a configuration may be useful when, for example, a preferred orientation is beneficial for the settlement and growth of the target product attached to the substrate, either so that the target product can grow toward the light in an upward direction during the early development of the target product, or in a downward direction from the bottom of the substrate during later stages of development. Materials of differing densities and solubilities may be layered in a sequence that is configured to cause a flip in the substrate once more and/or less dense layers dissolve from their respective sides and in the process, shift the center of gravity of the coated substrate across the horizontal plane of a longitudinal or transverse axis of the substrate.

In some embodiments, a density and/or buoyancy of the coating may be adjusted via injection of a gas (e.g., air or nitrogen) into the coating. For example, the density and thus buoyancy of the CaCO₃ based coat could also be controlled by sparging compressed air into the coating slurry as it is deposited on the substrate. This may cause air bubbles to be trapped in the mineralizing coating, thereby increasing its porosity and/or permeability, reducing its density, and/or controlling the rate that water diffuses through the coat after it is deployed to the ocean or other natural water body.

In some embodiments, the carbonaceous coating and/or substrate formed therefrom may be used in absence of the target product for carbon sequestration. For example, in the absence of additional biological growth, a floating but water absorbing material such as forestry wastes, agricultural wastes, and/or or other carbon sequestering terrestrial biomass could hold a carbonate material at the surface during the time needed for the dissolution process to occur. After dissolution process is complete, the floatation material included in the substrate (e.g., a naturally occurring material) may absorb water and sink. In some embodiments, the carbonaceous material may be a waterproof or water-resistant coating of the floatation, a coating of the floatation with no measurable waterproofing characteristics, or attached separately to the floatation. Such embodiments may provide a means of carbon sequestration that may be a combination of carbonate dissolution and terrestrial biomass removal that is independent of growth of the target product.

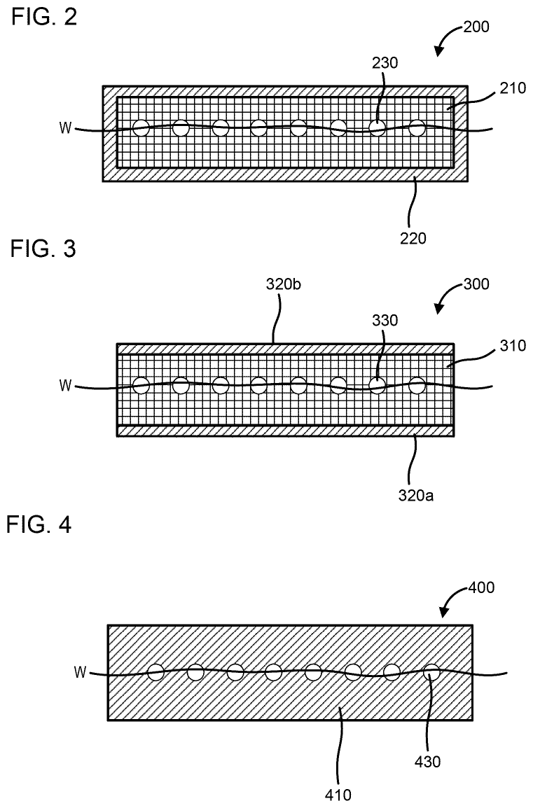

FIGS. 2-4 show various embodiments of a cultivation apparatus including a substrate that includes a coating formed from a carbonaceous material, and/or the substrate is formed from the carbonaceous material. For example, FIG. 2 is a schematic illustration of a cultivation apparatus 200 for growing a target product 230 (e.g., any of the target products described herein) and sequestering carbon that is deployed in a body of water W, according to an embodiment. The cultivation apparatus 200 includes a substrate 210 and a coating 220 formed form a carbonaceous material disposed around the substrate 210. In some embodiments, the substrate 210 may be formed from a natural-occurring material, for example, any of the naturally occurring material described herein with respect to FIG. 1. The coating 220 is disposed around the substrate 210. In some embodiments, the coating 220 includes CaCO₃. In some embodiments, the coating 220 may include an aggregate fraction, a silicic fraction, a metal fraction, binders, accelerants, additives, catalysts, and/or any other material, as previously described herein. While the target product 230 is shown as seeded in the substrate 210, in some embodiments, the target product 230 may be additionally, or alternatively, seeded in the coating 220. Moreover, the coating 220 may also be infused into the product, and/or may coat the target product 230 (e.g., to promote adhesion of target product 230, and/or provide nutrients to the target product 230). While shown as being a rectangular block, in other embodiments, the substrate 210 may have any suitable shape, for example, square, ovoid, circular, polygonal, asymmetric, irregular, etc. The coating 220 may be configured to transition from a first configuration to a second configuration to adjust a buoyancy of the seeded substrate, and/or to sequester carbon, as previously described herein.

FIG. 3 is schematic illustration of a cultivation apparatus 300, according to an embodiment. The cultivation apparatus 300 includes a substrate 310 that is seeded with a target product (e.g., any of the target products described herein) and is suspended in a body of water W. Different from the cultivation apparatus 200, the cultivation apparatus 300 includes a first coating 320a disposed on a first side of the substrate 310, and a second coating 320b disposed on a second side of the substrate 310 that may be opposite the first side. The first coating 320a and the second coating 320b may be formed from any of the materials, as described with respect to FIG. 1. In some embodiments, however, the first coating 320a may have first density that is greater than a second density of the second coating 320b. The higher density of the first coating 320a may cause the cultivation apparatus 300 to orient such that the denser first coating 320a is below the surface of the body of water W, while the lower density second coating 320b is above the surface of the body of water W, at least when the cultivation apparatus 300 is initially deployed in the body of water. Thus, the first coating 320a and the second coating 320b may cause the cultivation apparatus 300 to be oriented in a preferred orientation in the body of water W.

FIG. 4 is a schematic illustration of a cultivation apparatus 400, according to an embodiment. The cultivation apparatus 400 includes a substrate 410 embedded with a target product 430 and floating on a body of water W. However, different from the substrates 210 and 310, the substrate 410 is formed from a carbonaceous material (e.g., any of the carbonaceous materials described herein), instead of just having a coating formed the carbonaceous material. In some embodiments, the target product 430 may sequester carbon as it grows, as previously described. In some embodiments, the carbonaceous substrate 410 may also be configured to sequester carbon (e.g., in addition to the carbon sequestration by the target product 430), as previously described. In some embodiments, the target product 430 may be excluded such that carbon sequestration and/or mitigation is provided by the substrate 410.

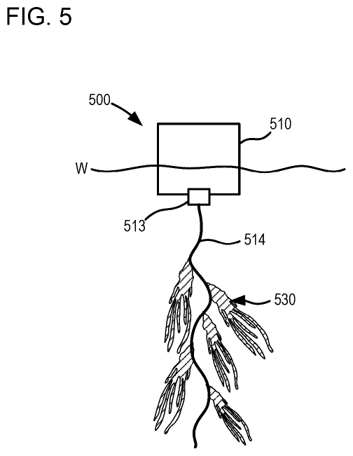

For example, FIG. 5 is a schematic illustration of a cultivation apparatus 500, according to an embodiment. In some implementations, the cultivation apparatus 500 can be used to cultivate one or more target products such as, for example, one or more macroalgae species and/or the like, or any other target product described herein. In some implementations, the cultivation apparatus 500 or any of the substrates or cultivation apparatus described herein (e.g., the cultivation apparatus 200, 300, 400) can be included in a deployment of tens, hundreds, thousands, tens of thousands, hundreds of thousands, or more cultivation apparatus. Every cultivation apparatus 500 (or any other cultivation apparatus described herein) in such a deployment may been seeded with and/or may have attached thereto one or more target products.

As described in detail herein, the deployment of cultivation apparatus 500 can occur at any suitable geographical location on or in any suitable body of water. As shown in FIG. 5, the cultivation apparatus 500 includes a first member 510, a second member 514, and an intermediate member 513 configured to reversibly couple the first member 510 to the second member 514. The cultivation apparatus 500 and/or the first, second, and intermediate members thereof, can be any suitable shape, size, and/or configuration. In some embodiments, for example, the cultivation apparatus 500 can be substantially similar to any of the cultivation apparatus (also referred to as “microfarms”) described in detail in U.S. Patent Publication No. 2021/0345589, filed Jun. 8, 2021, entitled “Systems and Methods for the Cultivation of Target Product,” the disclosure of which is incorporated herein by reference in its entirety (referred to herein as the “'589 publication”). The cultivation apparatus 500 can differ, however, with the inclusion of one or more coating that includes any of the carbonaceous materials described herein, which may be used to form at least portions of the cultivation apparatus 500.

In some embodiments, the cultivation apparatus 500 can be arranged in a modular configuration in which one or more portions of the first member 510, the second member 514, and/or the intermediate member 513 can be mechanically coupled to collectively form the cultivation apparatus 500. For example, in some implementations, a second member 514 can be seeded with, be coupled to, and/or or attached to one or more target products (or a target product can be attached to the second member 514) at a delivery and/or deployment system. In such implementations, the one or more portions of the cultivation apparatus 500 can be loaded into the delivery and/or deployment system and/or a component thereof, transported to a deployment location, assembled (e.g., the first member 510, the second member 514, and the intermediate member 513 can be at least temporarily coupled) on the delivery and/or deployment system as the delivery and/or deployment system approaches and/or is at the deployment location, and then deployed into a body of water at or near the deployment location. In some embodiments, the second members 514 may include, or may be coated with any of the coatings described herein, for example, to promote adhesion of the target product 530, and/or provide nutrients to the target product 530.

The first member 510 of the cultivation apparatus 500 can be any suitable shape, size, and/or configuration. In some embodiments, the first member 510 can be include the substrate or cultivation apparatus 200, 300, 400, or any other substrate or cultivation apparatus described herein. For example, in some embodiments, the first member 510 of the cultivation apparatus 500 can include and/or can form a growth substrate or the like configured to be seeded with and/or otherwise receive a target product such as one or more species of macroalgae gametophytes and/or sporophytes, as previously described herein. In some embodiments, the first member 510 can be configured to provide buoyancy to the various components of the apparatus 500 (with or without being seeded with a target product), allowing the apparatus 500 to float on a surface at least temporarily, or at a desired depth of the body of water W in which it is deployed. In some implementations, the first member 510 can be retrieved after a predetermined time and/or after a desired amount of target product growth or accumulation. In other implementations, the first member 510 can be configured to sink after a predetermined time and/or after a desired amount of target product growth or accumulation.

In some embodiments, the first member 510, which can also be referred to as a “substrate” or a “buoy” or any other selectively buoyant member, may be formed from a naturally occurring material, for example, any of the naturally occurring materials described herein. In some embodiments, at least a portion of the first member 510 may be coated with a coating formed from a carbonaceous material, or may be formed from the carbonaceous material, as described herein. In some embodiments, the first member 510 (e.g., in the form of hollow block) may include a mechanical, chemical, and/or biological timer/valve configured to release gas contained therein after a predetermined time (e.g., a time associated with and/or allowing for a desired amount of target product growth and/or accumulation), thereby reducing the buoyancy of the first member 510. In some embodiments, the first member 510 (e.g., any of the cultivation apparatus 200, 300, 400) or at least a portion thereof can be configured to partially or completely degrade and/or decompose after a threshold period of being deployed (e.g., in or on an ocean, etc.) and/or in response to or after the cultivation apparatus 500 sinking to the sea/ocean bottom.

In some embodiments, the first member 510 can include one or more portions that can degrade and/or decompose at different rates and/or at variable rates in response to environmental conditions. In some embodiments, the first member 510 can include a sealing member at least temporarily coupled to and/or at least temporarily disposed in the first member 510. In some implementations, the sealing member can be degradable, and/or automatically or manually decoupleable from the first member 510, thereby allowing the air and/or other gases contained therein to escape, and/or allow water to enter the first member 510. As such, the first member 510 (and thus, the cultivation apparatus 500) can be positively buoyant when initially deployed, allowed to float for a predetermined and/or threshold time after being deployed, and then allowed to sink as a target product seeded on or attached to the cultivation apparatus 500 grows and obtains biomass, as described in detail herein as well as in the '589 publication.

The second member 514 of the cultivation apparatus 500 can be any suitable shape, size, and/or configuration. The second member 514 can be coupled to the first member 510 and/or the intermediate member 513 (e.g., at a desired deployment location). In some embodiments, the second member 500 can be similar to and/or substantially the same as any of the second members of the cultivation apparatuses described in the '589 publication. For example, in some embodiments, the second member 514 can be one or more seeding lines, longlines, ropes, and/or the like. In some embodiments, the second member 514 can be similar to any of the substrates and/or can be formed from any of the naturally occurring materials described herein. In some embodiments, the second member 514 can include optional weight(s) such as metallic rings, mineralized layers, and/or the like (not shown) to provide negative buoyancy of and/or associated with the second member 514.

In some implementations, the second member 514 may be configured to receive one or more species of a target product 530 such as one or more species of macroalgae gametophytes and/or sporophytes, or any other target product described herein. For example, one or more portions and/or surfaces of the second member 854 can be formed of, include, and/or be coupled to a growth substrate (not shown), can be formed of any of the naturally occurring materials described herein, and/or can be included any of the coatings described herein, which in turn, is infused with a growth substrate, nutrients, fertilizers, binders, additives, and/or the like configured to facilitate seeding, attachment, and/or growth of a target product 530, as described above.

The intermediate member 513 of the cultivation apparatus 500 can be any suitable shape, size, and/or configuration. In some embodiments, the intermediate member 513 can be similar to and/or substantially the same as any of the intermediate members of the cultivation apparatuses described in the '589 publication. For example, in some embodiments, the intermediate member 513 can be similar, at least in part, to the first member 510 and/or second member 514. The intermediate member 513 is configured to couple at least temporarily the first member 510 to the second member 514. For example, one or more portions of the intermediate member 513 can be and/or can include an adhesive, glue, paste, cement, etc., one or more mechanical linkages such as ring(s), shackle(s), swivel(s), joint(s), and/or the like; one or more anchor points such as tie knot(s), thimble kit(s), hook(s), and/or the like; and/or any other suitable coupling.

In some embodiments, the intermediate member 513 can be formed of a degradable material, a compostable co-polyester, a cellulose-based material, any of the naturally occurring materials described herein, and/or the like. For example, the intermediate member 513 can be formed of and/or can include polyglycolide, polylactide, polyhydroxobutyrate, chitosan, hyaluronic acid, poly(lactic-co-glycolic), poly (caprolactone), polyhydroxyalkanoate, ECOFLEX®, ECOVIO®, and/or any other ocean compatible material(s) and/or combinations thereof. In some embodiments, the intermediate member 513 can be formed of any of the materials and/or combination of materials described, for example, in the '589 publication. In some embodiments, the intermediate member 513 may be formed from a naturally occurring material (e.g., any of the naturally occurring materials described herein). While examples of materials (e.g., degradable and/or compostable materials) are listed, it should be understood that other materials are possible, and the materials are not intended to be limited to those stated and/or referenced herein.

As described above with reference to the first member 510, the intermediate member 513 can be configured to degrade after a threshold or predetermined time of being deployed. In some implementations, the degrading of the intermediate member 513 can allow and/or can result in a decoupling of the first member 512 from the second member 514. In some embodiments, the intermediate member 513 can be configured to degrade after a desired amount of growth or accumulation of the target product 530 attached to the second member 514, as described above. In some embodiments, the intermediate member 513 can be configured to degrade under predetermined environmental conditions including but not limited to temperature, pressure, exposure to UV and/or visible light, and/or the like.

As described above, in some implementations, the first member 510 can be positively buoyant, while the second member 514 can be negatively buoyant and/or the target product 530 attached to the second member 514 can be negatively buoyant. Thus, when the intermediate member 513 decouples the first member 510 from the second member 514 (e.g., as a result of degrading or as a result of a mechanical decoupling), the first member 510 can float at or on a surface of the ocean, while the second member 514 and the target product 530 attached thereto can sink to the bottom or floor of the body of water (e.g., seafloor, ocean floor, etc.). The sinking of the second member 514 and the target product 530 attached thereto effectively sequesters an amount of carbon associated with and/or captured by the target product 530 and/or by the coating, and may also mitigate ocean acidification due to dissolution of the carbonaceous coating into the body of water W, as previously described herein.

In some embodiments, the second member 514 can be formed from the naturally occurring material, and may include the coating, or be formed form the carbonaceous material described herein, and may naturally degrade (e.g., after sinking). In some embodiments, the first member 810 that is formed from the naturally occurring material and/or the carbonaceous material, and may also be naturally degradable, or configured to degrade and/or otherwise decompose on the surface of the water or can be configured to degrade and sink to the bottom or floor of the body of water. In some embodiments, the first member 510 may degrade at a slower rate than the intermediate member 513 such that the degradation or otherwise decomposition of the intermediate member 513 causes detachment and sinking of the second member 514 and thereby, the target product 530.

In some embodiments, the cultivation apparatus 500 and/or one or more components thereof (e.g., the first member 510) can include and/or can be coupled to device(s) configured to sense, detect, and/or monitor growth of the target product 530, biomass generation, biomass yield, environmental characteristics or data, and/or any other data associated with a deployment of one or more cultivation apparatus. For example, in some embodiments, the cultivation apparatus 500 can include one or more sensors, cameras (e.g., underwater cameras and/or other imaging technologies), tracking devices (e.g., a Global Positioning System (GPS) tracking device, a Radio-Frequency Identification (RFID) device, and/or the like), remote sensing devices, telemetry devices, and/or any other suitable device such as any of those described in the '589 publication, U.S. patent application Ser. No. 17/957,681 (“the '681 application”), filed Sep. 30, 2022, entitled, “Systems and Method for Quantifying and/or Verifying Target Product Accumulation for Greenhouse Gas Sequestration,” and/or U.S. patent application Ser. No. 18/156,615 (“the '615 application”), filed Jan. 19, 2023, entitled, “Systems and Methods for Monitoring Accumulation of a Target Product,” the disclosures of which are incorporated herein by reference in their entireties.

In some implementations, including such device(s) in or coupling such device(s) to the buoyant first member 510 can allow the retrieval of the first member 510 and device(s) after, for example, the second member 514 has been decoupled from the first member 510. In such implementations, the first member 510 can be formed from any of the naturally occurring materials described herein and may also include any of the coating describe herein, but can be treated and/or otherwise configured to delay, reduce, and/or substantially prevent degradation, thereby allowing retrieval of the first member 510 (e.g., after being decoupled from the second member 514). As such, data associated with and/or collected at or by the cultivation apparatus 500 can be aggregated, analyzed, calculated, processed, etc. to allow for a determination, estimation, and/or prediction of, for example, historical or current target product growth or growth rates, biomass production, biomass yield, sinking rate(s), location(s) of a deployment, dispersion of a deployment, environmental conditions in an area corresponding to a deployment, and/or any other desired information associated with the cultivation apparatus 500 and/or a deployment of any number of cultivation apparatus. Moreover, in some implementations, such information can be used and/or can otherwise inform one or more predictions and/or quantifications associated with carbon capture and/or sequestration rates, quantities, capacities, and/or the like, as described in detail in the '589 publication. In some embodiments, the data collected by such devices may be wireless transmitted to remote data collection centers, for example, located on shore, or on boats, buoys, or drones floating in proximity of the location on the body of the water where aggregates or arrays of the cultivation apparatus 500 are deployed. In such embodiments, the device(s) may also be formed form biocompatible materials, such that device(s) sink into the body of water with the cultivation apparatus, and can eventually degrade or decompose in the body of water.

As described above, the cultivation apparatus 500 can be seeded with one or more species of a target product 530 such as macroalgae, and then deployed in a body of water such as an ocean, sea, lake, river, brine, etc. In some instances, the hatching and/or the seeding of one or more components of the cultivation apparatus 500 can be initiated at an onshore hatchery facility and/or the like. The components of the cultivation apparatus 500 can then be transferred, included, and/or incorporated into a delivery and/or deployment system. The delivery and/or deployment system can be configured to receive, house, and/or accommodate the components of the cultivation apparatus 500, provide the conditions suitable for further development of the seeded target product(s), transport the components of the cultivation apparatus 500 to a geographical location suitable for deployment, and facilitate rapid assembly of the cultivation apparatus 500 and subsequent deployment. In other instances, the hatching and/or the seeding of one or more components of the cultivation apparatus 500, as well as their subsequent development, transportation and deployment can be performed at or on the delivery and/or deployment system (e.g., a vessel).

### EXAMPLE

The following examples describe various coating compositions that may be used to coat or form substrates for a cultivation apparatus, and/or described various methods of coating such substrates. It should be appreciated that these examples are for illustrative purposes only and are not intended to limit the disclosure.

Coating Formulations: The coating may include crushed CaCO₃ (e.g., limestone, or dolomite substitution, full or partial) having a grain size of about 0.1 mm or less. In some embodiments, the CaCO₃ may include about 50% to about 90% by weight, inclusive, of the coating formulation, and may provide the benefits of providing a ballast, drive steady thinning of the coating in the body of water through dissolution, and carbon dioxide sequestration via dissolution.

The coating may also include Ca(OH)₂ (or CaO, which may be less expensive per mole than Ca(OH)₂ but more caustic than Ca(OH)₂). The Ca(OH)₂ may be in powdered form, and may be included in a concentration of about 7.5% by weigh of the CaCO₃ portion of the coating or about 10% by weight after mineralization to CaCO₃. The Ca(OH)₂ may serve as a binder to bind the crushed limestone and pumice, to drive steady thinning of the coating and CO₂ sequestration via dissolution, and/or to sequester CO₂ directly from the atmosphere during mineralization to CaCO₃ while drying.

The coating may also include pumice having a grain size of 1 mm or less (e.g., less than 25% of the thickness of the coating), for example, small enough to prevent weakening strength of the coating but large enough to maintain a relatively high ratio of interior porosity to fractured pores on perimeter. The pumice may be included in a concentration of about 0% to about 40%, inclusive, by weight of the coating. The pumice may provide buoyancy to the coating and thereby, the substrate.

The coating may also include nutrients such as, for example, nitrogen (N), phosphorus (P), iron (Fe), etc. in appropriate Redfield ratios, to provide slow release of nutrients for attached/seeded target product (e.g., algae). The nutrients may be provided in powder form to increase reactivity, and may include about 0% to about 90% by weight, inclusive, of the CaCO₃ portion of the coating, for example, determined from the rate of dissolution of the coating (which releases the nutrients) and the target nutrient concentrations in the waters adjacent to the target product on the substrate.

The coating may also include fresh water, which may be used to create a slurry of dry coating materials, control a viscosity of the slurry to produce a desired thickness of the coating, and/or to catalyze a binding reaction. A volumetric ratio of the water to coating materials may be approximately 1:1 (e.g., for a coat of dry density=0.46 including 70% mass of finished substrate, which translates to about 158,500 gallons fresh water per hour when producing about 400 tons of substrate per hour). Water ratio may also be adjusted to achieve a viscosity to yield a desired coat thickness while keeping pumice grains in suspension. In some instances, seawater may be substituted for freshwater (in the same proportions) in circumstances where freshwater is too costly or unavailable and/or when it is desirable to increase solubility of the coating, resulting in an about 15% reduction in strength of the coating.

The coating may also include algal seed and binder, for example, for inoculation of substrate (e.g., a wood substrate) with stabilized algal seed that will be protected during transport and deployment of wood substrate and will grow and sequester carbon once deployed to the body of water. The algal seed and binder may have a thickness of 1 mm or less, and the algal seed, spore, or young plant may be preserved in a gel or other stable binder.

Methods of coating substrates: In some implementations, a coating process may be performed in cages suspended from a circulating cable (e.g., ski chair lift cable) or along a walled conveyer having a footprint within about 1,500 m² to about 2,000 m², inclusive.

Cabled cage design: In some implementations, approximately 25 Teflon™ coated cages (6 m×3 m×1 m) may be suspended from a recirculating cable moving through the process at a rate of about 50 cages per hour. In some instances, such an arrangement could meet a production target of about 400 ton/hr. Cages may be lowered into vessels containing the various coating mixtures and transported through furnace tunnels between coating applications.

Conveyer design: In some implementations, a 6 m wide×0.5 m deep walled conveyer system moving at a rate of approximately 20 cm/s through a coating/heating processes could meet a production target of about 400 ton/hr. In each of these implementations, total processing time may be about 30 minutes.

Formulation of dry coating: In some implementations, crushed limestone, Ca(OH)₂, pumice, and/or nutrients may be added to a horizontal or angled rotating mixing drum that is, for example, tolerant of caustic or high-pH conditions resulting from a Ca(OH)₂ (less caustic) or a CaO (more caustic) binder through grain elevator-type delivery systems supplied from large external storage containers. Raw materials can be added at rates that reflect their proportions in the coating.

Hydration of coating: In some implementations, water can be added to the rotating drum once the dry mixture has been homogenized. After the mixture in the rotating drum achieves a desired (e.g., minimum or substantially minimum) viscosity that keeps the pumice and crushed limestone fragments in suspension (thereby yielding a mechanically stronger homogeneous binder-supported texture, rather than a weaker heterogeneous grain-supported texture), the slurry can be transported to a closed basin with comparable tolerance for caustic (high-pH) solutions.

Transport and drying of wood substrate: In some implementations, a wooden substrate can be conveyed from a grain-elevator-type storage silo into TEFLON™ coated bottom-opening trays or cages hung sequentially along a recirculating cable. Cages can be passed through an enclosed high temperature furnace for approximately 5 minutes to drive off moisture.

Coating of wood substrate: In some implementations, cages holding raw wood substrate can be transported to and immersed into the CaCO₃ pumice-nutrient-water slurry until the wood substrate is coated at the target thickness. Coating thickness may be selected and/or optimized to prolong float time to increase target product growth (e.g., maximize macroalgal growth). Alternatively, a coating thickness may be increased to minimize float time to promote rapid sinking of wood substrates that will not be inoculated/seeded with macroalgae to limit microbial remineralization of the substrate as it sinks through the water column and buried on or by the floor of the body of water. In some implementations, the thickness of the coating may be controlled by varying the viscosity of the slurry through water addition, with higher viscosity yielding a thicker coating. In some instances, tolerance of coating thickness may be about 20% of a desired or optimal thickness to avoid under or over coating of the substrate, both of which may affect (e.g., shorten) float time of substrate. In some implementations, the less-dense pumice-infused coating may reduce a sensitivity of float time to deviations in coating thickness providing support for the 20% tolerance of the coating thickness.

Drying of CaCO₃-pumice-nutrient coated chips: In some implementations, the cage containing the CaCO₃-coated chips can be transported along the cabled circuit into a high-temperature furnace tunnel to expedite drying of the coating slurry and mineralization of the binder (e.g., for approximately 20 minutes). Conversion of Ca(OH)₂ binder to CaCO₃ is slightly exothermic and thus, may accelerate this drying process.

Inoculation of substrates with algal seed: In some implementations, the dried cages can be dipped into vessels of algal seed suspended in an appropriate organic and/or gel binder that will adhere to the CaCO₃ coating, thereby protecting the young algae from desiccation during transport of the substrate to the ocean and/or from environmental factors during early-stage development. In some instances, the binder may eventually dissolve once the alga has attached to the coating and no longer requires a same degree of protection from the environment.

Partial drying of seed coating: In some implementations, cages containing the wet seed coating can be transported through a low-temperature furnace to promote gentle drying of the seed coating (e.g., for about 2 minutes to about 3 minutes).

Transport of coated and seeded substrates: In some implementations, substrates with a fully cured CaCO₃ coating and partially dried seed coating can be transported by cabled cage to one or more escalating conveyor belts (e.g., about 3 m wide and running in parallel) that originate in the coating facility and terminate at one or more loading area(s) of a ship, barge, train, vessel, or other container that will transport the coated and seeded substrates to the sea (or other body of water) or their next leg of transport in route to the sea (or other body of water).

Final drying of coated substrate and delivery to transport vessel: In some implementations, partially dried substrates can be released through the bottom of the cabled cages onto the escalating conveyors in, for example, a thin layer. In some implementations, the partially dried substrates can be passed through a heated tunnel to gently complete the drying process of the seed coating layer so that the substrates are completely dried when they reach, for example, a cargo hull of a ship, vessel, and/or other transport container. Optionally, the coated and seeded substrates may be dropped into the final transport vessel from sufficient height to promote disaggregation of substrates that may have become loosely bound during the coating process.

Cleaning of cages after delivery of final coated/seeded substrate: In some implementations, cages may be immersed in a sonicated bath to descale CaCO₃ built up on the cage walls built-up throughout the coating process, for example, facilitated by the TEFLON™ coating on the cages. In some instances, the descaled coating can be recycled as CaCO₃ aggregate in the coating mixture after collection.

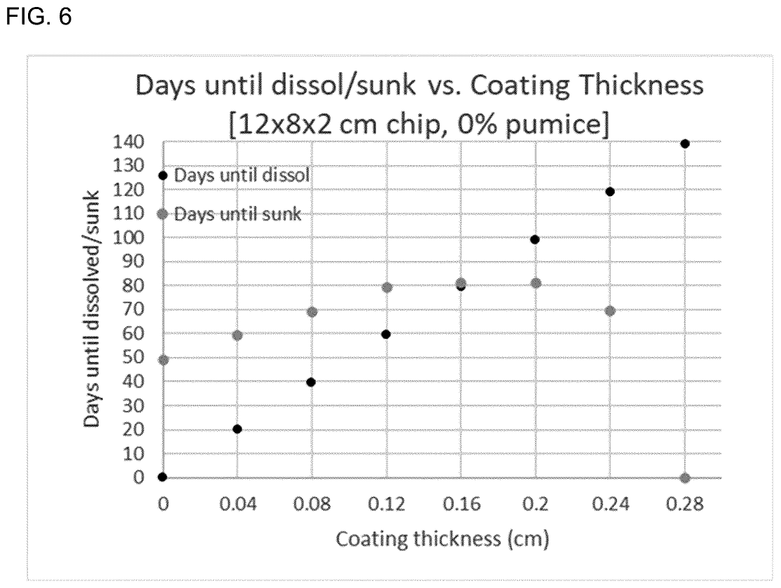

FIGS. 6-12 are plots illustrating the impact of pumice concentration and thickness of the coating on the floating and sinking character of a substrate including the coating. For example, FIG. 6 is a plot of coating thickness of a carbonaceous coating on a substrate, which does not include any pumice, vs. (1) a floating time of the substrate (i.e., a time from first deployment of the substrate in the body of water until the substrate sinks) and (2) a dissolution time of the coating (i.e., a time after which the coating is substantially dissolved in the body of water). In this example, the substrate is, a 12 cm×8 cm×2 cm substrate formed of wood chips and coated with a coating having a thickness in a range of 0 cm to 0.28 cm. As shown in FIG. 6, the floating time increases up to a thickness of 0.16 cm of the coating (e.g., from about 50 days to about 80 days), but starts to decrease thereafter, while the dissolution time continues to increase as the coating thickness increases.

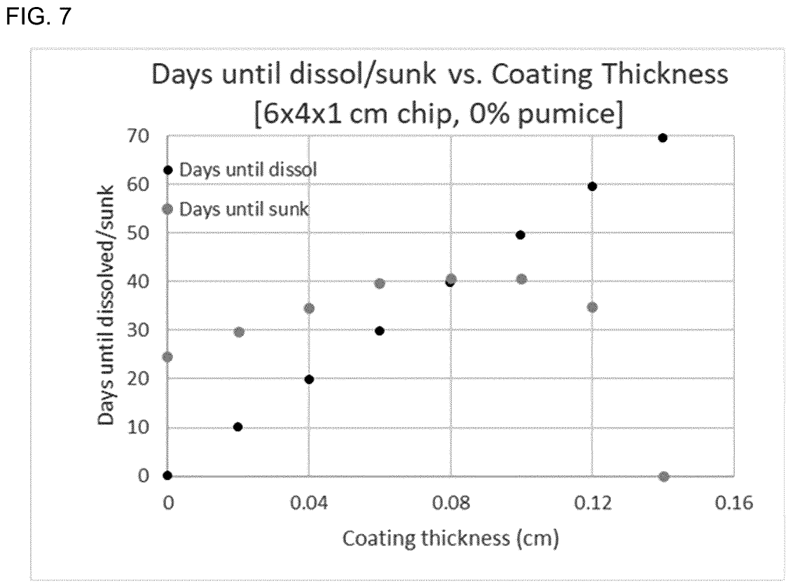

FIG. 7 is a plot of coating thickness of a carbonaceous coating on a substrate, which does not include any pumice vs. (1) the floating time of the substrate and (2) the dissolution time of the coating. In this example, the substrate is a 6 cm×4 cm×1 cm substrate formed of wood chips and coated with a coating having thicknesses in a range of 0 cm to 0.14 cm. As shown in FIG. 7, the floating time increases up to a thickness of 0.08 cm of the coating (e.g., from about 25 days to about 40 days), but starts to decrease thereafter, while the dissolution time continues to increase as the coating thickness increases.

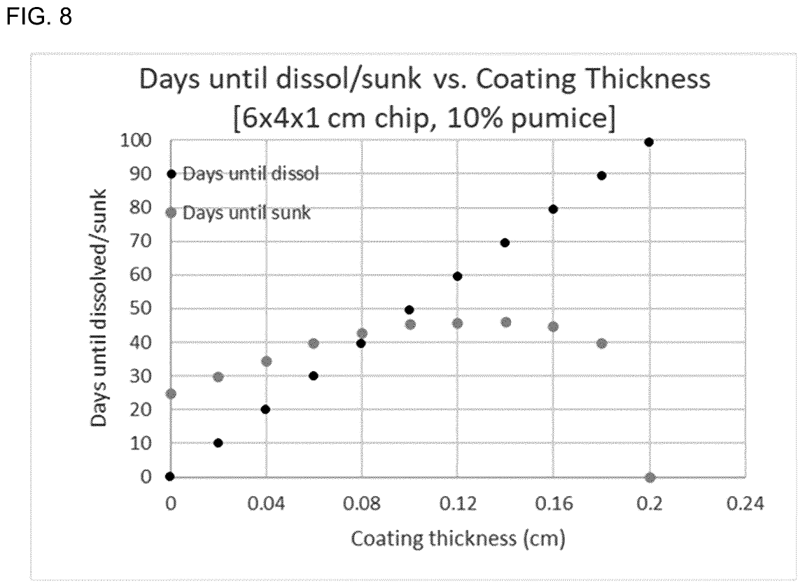

FIG. 8 is a plot of coating thickness of a carbonaceous coating on a substrate, which includes 10% pumice by weight vs. (1) the floating time of the substrate and (2) the dissolution time of the coating. In this example, the substrate is a 6 cm×4 cm×1 cm substrate formed of wood chips and coated with a coating having thicknesses in a range of 0 cm to 0.2 cm. As shown in FIG. 8, the floating time increases up to a thickness of 0.12 cm of the coating (e.g., from about 25 days to about 45 days), but starts to decrease thereafter, while the dissolution time continues to increase as the coating thickness increases.

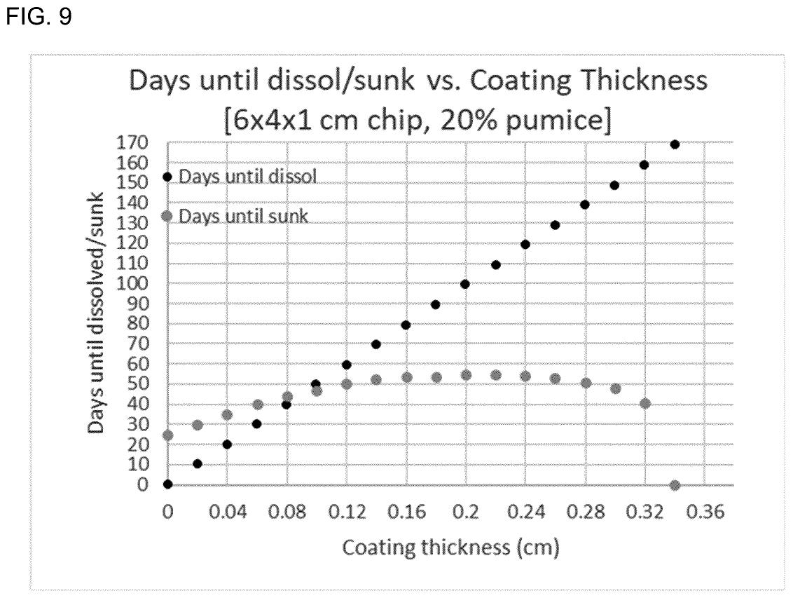

FIG. 9 is a plot of coating thickness of a carbonaceous coating on a substrate, which includes 20% pumice by weight vs. (1) the floating time of the substrate and (2) the dissolution time of the coating. In this example, the substrate is a 6 cm×4 cm×1 cm substrate formed of wood chips and coated with a coating having thicknesses in a range of 0 cm to 0.34 cm. As shown in FIG. 9, the floating time increases up to a thickness of 0.2 cm of the coating (e.g., from about 25 days to about 55 days), but starts to decrease thereafter, while the dissolution time continues to increase as the coating thickness increases.

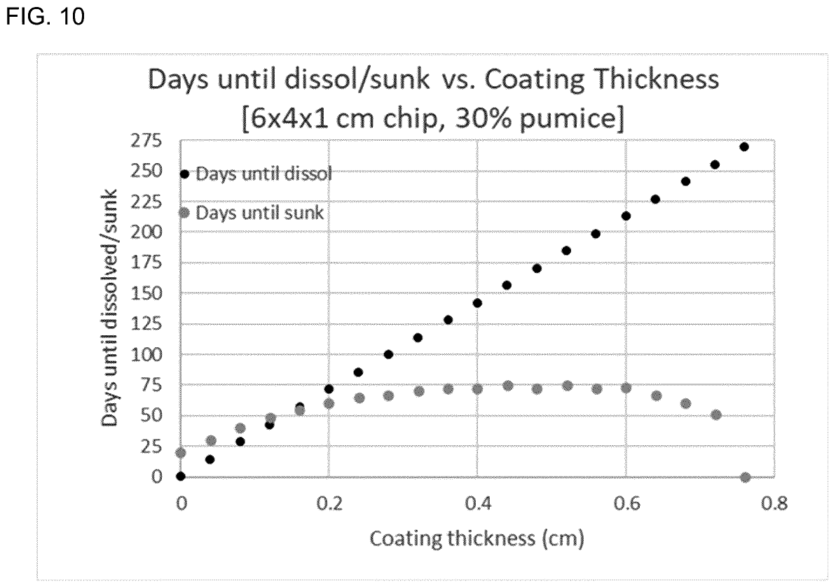

FIG. 10 is a plot of coating thickness of a carbonaceous coating on a substrate, which includes 30% pumice by weight vs. (1) the floating time of the substrate and (2) the dissolution time of the coating. In this example, the substrate is a 6 cm×4 cm×1 cm substrate formed of wood chips and coated with a coating having thicknesses in a range of 0 cm to about 0.7 cm. As shown in FIG. 10, the floating time increases up to a thickness of 0.4 cm-0.6 cm of the coating (e.g., from about 25 days to about 75 days, with about 0.4 cm to about 0.6 cm thickness providing about the same floating time), but starts to decrease thereafter, while the dissolution time continues to increase as the coating thickness increases.

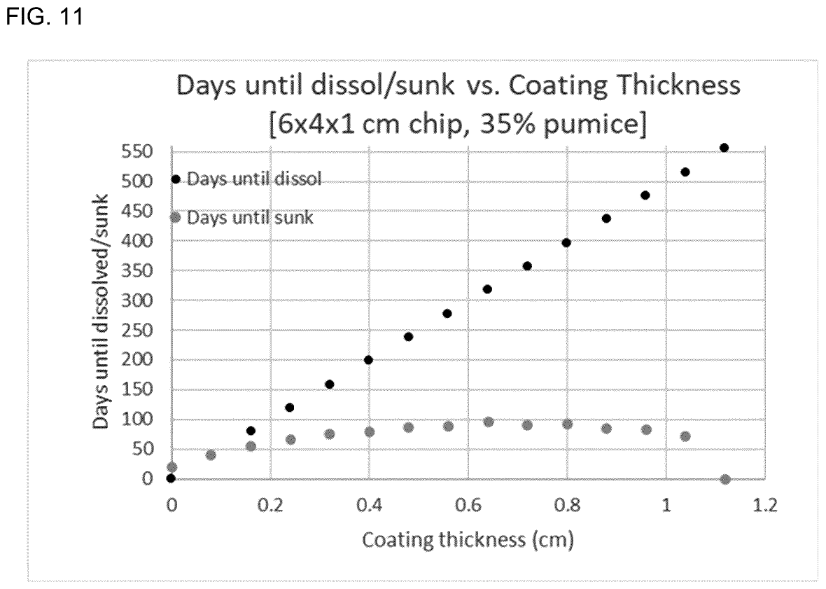

FIG. 11 is a plot of coating thickness of a carbonaceous coating on a substrate, which includes 35% pumice by weight vs. (1) the floating time of the substrate and (2) the dissolution time of the coating. In this example, the substrate is a 6 cm×4 cm×1 cm substrate formed of wood chips and coated with a coating having thicknesses in a range of 0 cm to about 1.10 cm. As shown in FIG. 11, the floating time increases up to a thickness of about 0.65 cm of the coating (e.g., from about 25 days to about 100 days), but starts to decrease thereafter, while the dissolution time continues to increase as the coating thickness increases.

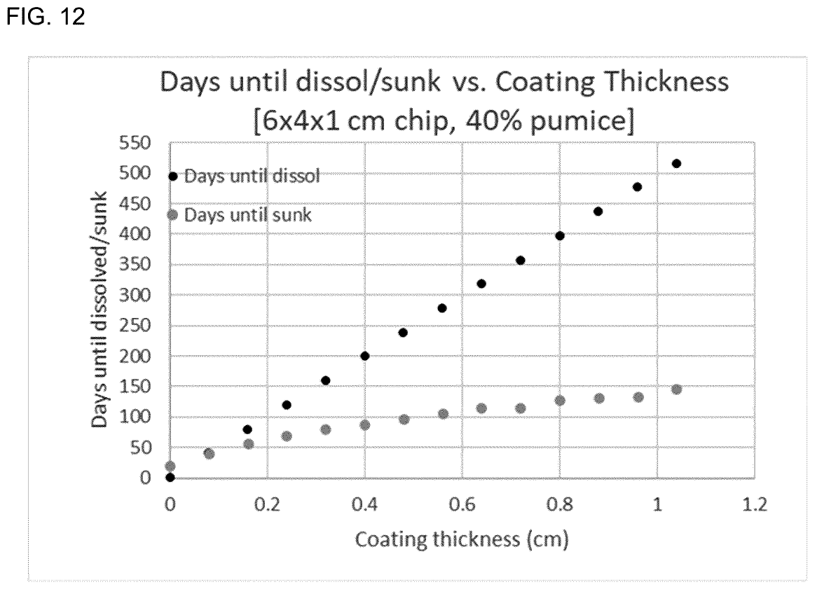

FIG. 12 is a plot of coating thickness of a carbonaceous coating on a substrate, which includes 40% pumice by weight vs. (1) the floating time of the substrate and (2) the dissolution time of the coating. In this example, the substrate is a 6 cm×4 cm×1 cm substrate formed of wood chips and coated with a coating having thicknesses in a range of 0 cm to about 1.15 cm. As shown in FIG. 12, the floating time continued to increase up to the thickness of 1.15 cm (e.g., from about 25 days to about 150 days). Among the various coatings described above with reference to FIGS. 6-12, the coating including 40% pumice by weight at a thickness of 1.15 cm provided the longest time of about 150 days. In this manner, a concentration of the coating in the coating may be adjusted to control the floating characteristics (e.g., floating time) of the substrate.

It is important to note that the construction and arrangement of the various embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the any of the teachings and/or advantages of the subject matter described herein. Other substitutions, modifications, changes, and/or omissions may also be made in the design, operating conditions, and/or arrangement of the various embodiments without departing from the scope of the disclosure. Where schematics and/or embodiments described above indicate certain components arranged in certain orientations or positions, the arrangement of components may be modified.

While this specification contains many specific implementation details, these should not be construed as limitations on the scope of any embodiments or use of embodiments, or of what may be claimed, but rather as descriptions of features or aspects specific to particular implementations. Certain features and/or aspects described in this specification in the context of separate implementations can also be implemented in combination in a single implementation. Conversely, various features and/or aspects described in the context of a single implementation can also be implemented in multiple implementations separately or in any suitable subcombination. Moreover, although features may be described above as acting in certain combinations and even initially claimed as such, one or more features from a combination can in some cases be excised from the combination to define and/or form a subcombination or variation of a subcombination thereof.

Thus, while particular implementations have been described, other implementations are within the scope of the disclosure and the appended claims. In some cases, the actions recited herein can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed:

1. A method, comprising:
forming a substrate;
coating at least a portion of the substrate to form a coated substrate;
deploying the coated substrate into a body of water, the coated substrate being at least one of pre-seeded with a target product before being deployed or configured to attract target product present in the body of water so as to become seeded with the target product after being deployed; and
allowing the coating to transition from a first configuration to a second configuration to adjust a buoyancy of the coated substrate.

2. The method of claim 1, wherein the substrate includes a naturally occurring material.

3. The method of claim 1, wherein a buoyancy of the coated substrate when the coating is in the first configuration is greater than a threshold buoyancy and a buoyancy of the coated substrate when the coating is in the second configuration is less than a threshold buoyancy.

4. The method of claim 3, wherein a first volume of the coating in the first configuration is greater than a second volume of the coating in the second configuration.

5. The method of claim 1, wherein the coating is formulated to sequester carbon from the atmosphere as the coating transitions from the first configuration to the second configuration.

6. The method of claim 1, wherein the coating includes CaCO₃.

7. The method of claim 1, wherein the coating includes a carbonaceous material.

8. The method of claim 1, wherein the body of water is an ocean, the coating is formulated to reduce ocean acidification as the coating transition from the first configuration to the second configuration.

9. The method of claim 1, wherein the body of water is an ocean, the coating is formulated to increase ocean uptake of atmospheric carbon dioxide by increasing surface water alkalinity as the coating transitions from the first configuration to the second configuration.

10. The method of claim 1, wherein when the coated substrate is configured to attract the target product, the coated substrate includes at least one binder to facilitate adhesion of the target product to the substrate.

11. A method, comprising:
forming a substrate;
coating at least a portion of the substrate to form a coated substrate;
allowing a seeded target product on the coated substrate to grow for a period of time;
deploying the coated substrate into a body of water after the period of time; and
allowing the coating to transition from a first configuration to a second configuration to adjust a buoyancy of the coated substrate.

12. The method of claim 11, wherein the period of time is a period of time for the target product to be integrated within the coated substrate.

13. The method of claim 11, wherein the substate includes additives configured to promote growth of the target product.

14. The method of claim 11, wherein the substrate includes additives configured to suppress contamination of the target product.

15. A method, comprising:
forming a substrate;
coating at least a portion of the substrate to form a coated substrate;
seeding at least one of the coating and the substrate with a target product;
deploying the coated substrate into a body of water;
allowing the coating to transition from a first configuration to a second configuration to adjust a buoyancy of the coated substrate.

16. The method of claim 15, wherein the coating includes a silica fraction configured to enhance buoyancy of the coating and/or the substrate.

17. The method of claim 15, wherein the coating is an aerated material including a surfactant foam.

18. The method of claim 15, wherein the coating includes an accelerant configured to alter at least one of the rate of hydration and the rate of mineralization of the coating.

19. The method of claim 15, wherein seeding at least one of the coating and the substrate with a target product includes mechanically trapping target product within pores of at least one of the coating and the substrate.

20. The method of claim 15, wherein seeding at least one of the coating and the substrate with a target product includes infusing at least one of the coating and the substrate with target product.
